(19) United States
(12) Patent Application Publication
(10) Pub. No.: US 2026/0188536 A1
(43) Pub. Date: Jul. 2, 2026

(54) MODE-MATCHING COLLECTED ION FLUORESCENCE TO A SINGLE MODE FIBER WITH INTERCHANGEABLE IMAGING

(71) Applicant: IonQ, Inc., College Park, MD (US)

(72) Inventors: Shantanu DEBNATH, Lanham, MD (US); Bo ZHAO, Gainsville, FL (US); Tan Liu, Frederick, MD (US)

(21) Appl. No.: 18/911,018

(22) Filed: Oct. 9, 2024

Related U.S. Application Data
(60) Provisional application No. 63/588,896, filed on Oct. 9, 2023.

(51) Int. Cl. G21K 1/20; G06N 10/40; H04N 23/55; H04N 23/695; H04N 23/90

(52) U.S. Cl. CPC G21K 1/20; G06N 10/40; H04N 23/55; H04N 23/695; H04N 23/90

(57) ABSTRACT

Aspects of the present disclosure relate to a quantum information processing (QIP) system that includes an ion trap inside a vacuum enclosure with a vacuum window. The QIP system includes an imaging objective, located at a first position, configured to focus light emitted through the vacuum window from a trapped ion into a single mode (SM) fiber at a second position. The QIP system includes a first camera, a second camera, a pick-off mirror, and an imaging lens, used in combination to align the imaging objective and the SM fiber in order to minimize (1) an objective tilt angle between an optical axis of the imaging objective and a normal axis to the vacuum window and (2) a fiber tilt angle between an axis of the SM fiber and the optical axis of the imaging objective.

### CROSS-REFERENCE TO RELATED APPLICATIONS

This application claims the benefit of U.S. Provisional Application No. 63/588,896, filed Oct. 9, 2023, which is herein incorporated by reference.

### TECHNICAL FIELD

Aspects of the present disclosure relate generally to systems and methods for use in the implementation, operation, and/or use of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

For example, in the case of connections of quantum computers, remote modules of trapped ion quantum computers may be connected by using photons. In order to achieve such connections, spontaneously emitted single photons from individual qubits need to be collected in single mode optical fibers to carry them over distances. The fidelity and speed of this operation critically depends on the collection efficiency of emitted photons by single mode fibers. An imaging objective with a high numerical aperture of light collection is usually chosen to focus the collected light from a single ion into a single mode fiber. It is required that: (a) the imaging system is near diffraction limited, or in other words, is free of optical aberrations, and (b) the imaging system is mode matched to the mode of the optical field of a single mode fiber to achieve maximum coupling efficiency. Both of the conditions above are challenging to achieve simultaneously.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In an exemplary aspect, the techniques described herein relate to a quantum information processing (QIP) system including: a vacuum enclosure with one or more vacuum windows allowing transmission of light in and out of the vacuum enclosure; an ion trap, inside the vacuum enclosure, configured to trap at least one ion; an imaging objective, located at a first position, configured to focus light emitted through the one or more vacuum windows from the at least one trapped ion into a single mode (SM) fiber at a second position, wherein the imaging objective has a first objective tilt angle between an optical axis of the imaging objective and a normal axis to the one or more vacuum windows, and the SM fiber has a first fiber tilt angle between an axis of the SM fiber and the optical axis of the imaging objective; and a first camera, a second camera, a pick-off mirror, and an imaging lens, used in combination to align the imaging objective and the SM fiber in order to minimize the first objective tilt angle and the first fiber tilt angle.

In some aspects, the techniques described herein relate to a method for aligning an imaging objective and a single mode (SM) fiber in a quantum information processing (QIP) system, the method including: setting the imaging objective at a first position, wherein the imaging objective focuses light emitted through one or more vacuum windows from at least one trapped ion into the SM fiber located at a second position, wherein the imaging objective has a first objective tilt angle between an optical axis of the imaging objective and a normal axis to the one or more vacuum windows, and the SM fiber has a first fiber tilt angle between an axis of the SM fiber and the optical axis of the imaging objective; and aligning the imaging objective and the SM fiber in order to minimize the first objective tilt angle and the first fiber tilt angle, using a combination of a first camera, a second camera, a pick-off mirror, and an imaging lens.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an imaging system of collecting light emitted by a trapped ion into a single-mode (SM) fiber.

FIG. 5 illustrates two alignment phases of the imaging system that collects light emitted by the trapped ion into the SM fiber.

FIG. 6 illustrates an additional alignment phase of the imaging system that collects light emitted by the trapped ion into the SM fiber.

FIG. 7 illustrates two additional alignment phases of the imaging system that collects light emitted by the trapped ion into the SM fiber.

FIG. 8 illustrates a method for collecting light emitted by a trapped ion into the SM fiber.

FIG. 9 illustrates a detailed method for collecting light emitted by a trapped ion into the SM fiber across various alignment phases.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

The present disclosure describes an alignment technique of an imaging system that enables connections between remote modules of trapped ion quantum computers. As mentioned previously, this involves collecting spontaneously emitted single photons from individual qubits in single mode optical fibers to carry them over distances. An imaging objective with a high numerical aperture of light collection focuses the collected light from a single ion into a single mode fiber. To optimize this collecting process, the imaging system should be free of optical aberrations, and should be mode matched to the mode of the optical field of a single mode fiber to achieve maximum coupling efficiency.

Even if a high numerical aperture objective meets diffraction limited performance, it is not guaranteed that installing it into the imaging system of the trapped ion quantum computer will not introduce aberrations. It is therefore necessary to actively align the whole imaging system to achieve a diffraction limited performance.

Because the single mode (SM) fiber coupling is extremely sensitive to misalignments and aberrations, it is not robust to the alignment process as it can get lost entirely even for small changes in the alignment parameters. Accordingly, the present disclosure also describes an optical subsystem that may be interchanged with single mode fiber imaging, and robustly captures a signal of optical aberrations during the alignment of the imaging system. Using the interchangeable optics, one can optimize the aberrations and mode matching of ion fluorescence to an SM fiber.

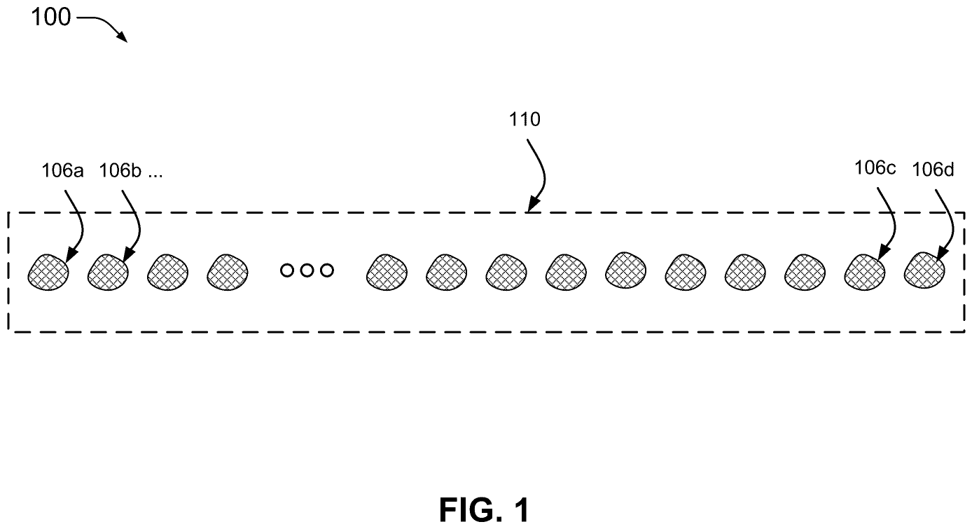

Solutions to the issues described above are explained in more detail in connection with FIGS. 1-8, with FIGS. 1-3 providing a background of QIP systems or quantum computers, and more specifically, of atomic-based QIP systems or quantum computers.

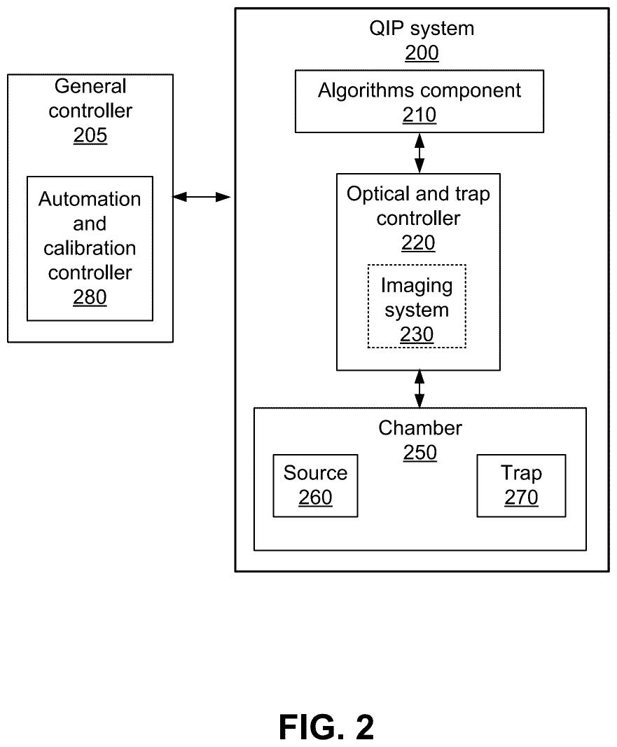

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap may be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped may be configurable and more or fewer ions may be trapped. The ions may be Ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, imaging systems, and optical components that are used to provide the optical beams that interact with the atoms or ions in the trap. Imaging systems that include multiple components may be referred to as optical assemblies. The optical beams are used to set up the ions, to perform or implement quantum algorithms, quantum applications, or quantum operations with the ions, and to read results from the ions. Control of the operations of laser, imaging systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, imaging systems, and optical components may be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 may be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the QIP system 200 with the optical elements of a beam shaping structure as arranged therein.

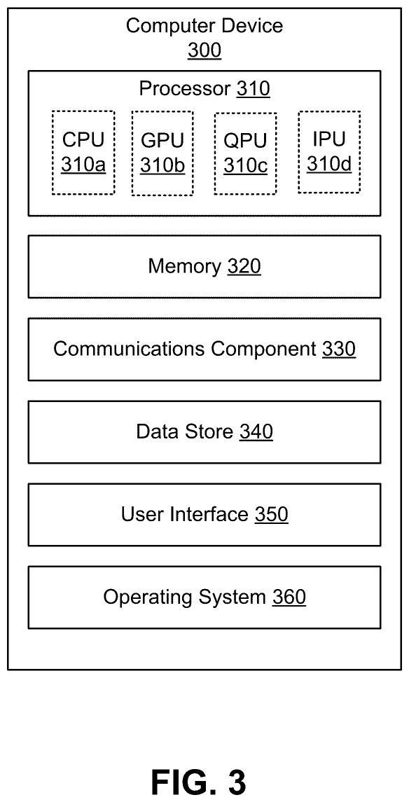

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which may be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, in one or more implementations, the QIP systems as disclosed herein include structures inserted into the QIP system that improve the efficiency of trapping ions relative to conventional trapping structures.

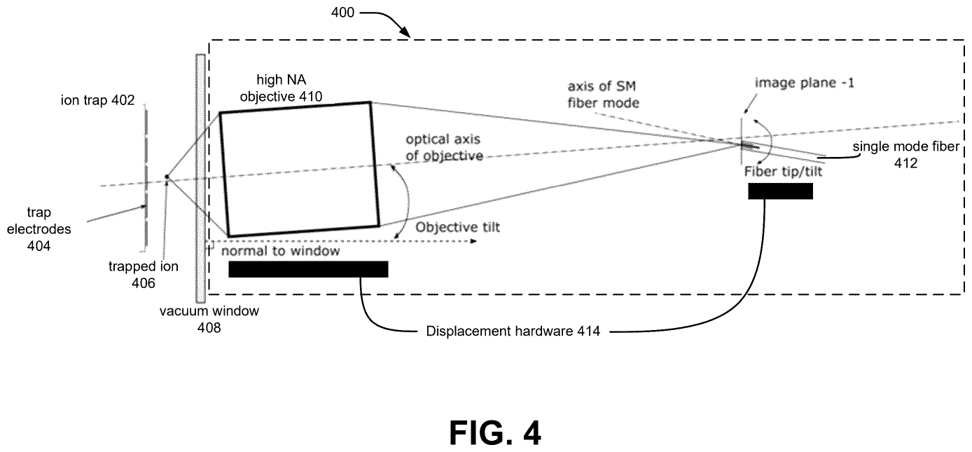

FIG. 4 illustrates an imaging system 400 for collecting light emitted by a trapped ion 406 into a single-mode fiber 412. Imaging system 400 includes a high numerical aperture (NA) objective 410 and single mode fiber 412. In some aspects, imaging system 400 corresponds to imaging system 230 described in FIG. 2, albeit with different components. For example, imaging system 400 may be implemented instead of imaging system 230 in QIP system 200 to improve the efficiency and accuracy of trapping ions in the ion trap 402. Likewise, ion trap 402 corresponds to trap 270, and vacuum window 408 may be a window in chamber 250.

The surface ion trap 402 illustrated uses a planar arrangement of trap electrodes 404 with the ion 406 trapped a certain distance above the surface. One or more vacuum window(s) 408 allow the transmission of light in and out of a vacuum enclosure such as chamber 250. High NA objective 410 images the collected light onto image plane-1, where the SM fiber 412 is situated.

FIG. 4 illustrates various misalignment parameters such as fiber-tip/tilt, which indicates the angle between the axis of SM fiber 412 and the optical axis of the high NA objective 410. To achieve perfect alignment, the value of fiber-tip/tilt should be zero degrees. Another parameter that influences alignment is the objective tilt, which indicates the angle between the optical axis of high NA objective 410 and the normal to the vacuum window. To achieve perfect alignment, the value of the objective tilt should be zero degrees as well.

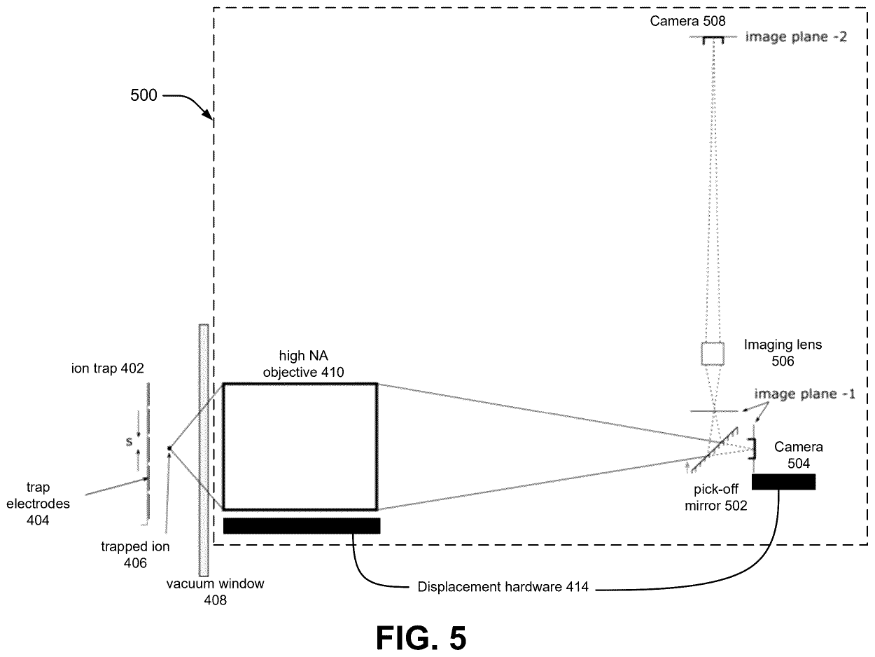

FIG. 5 illustrates two alignment phases for imaging system 400 that collects light emitted by trapped ion 406 into SM fiber 412. In some aspects, the tilting and positioning steps described in the present disclosure may be performed by displacement hardware 414 configured to perform precise movements. The displacement hardware 414 may be a movable mount or a robotic arm.

The first alignment phase involves replacing SM fiber 412 with camera 504, which is placed at the same position as SM fiber 412 in image plane-1 as prescribed by the optical design of imaging system 400. High NA objective 410 is then aligned by translation in X, Y and Z directions and rotation in tip and tilt to achieve an initial coarse alignment and for correcting aberrations as indicated by the ion image analysis by the camera at image plane-1. The ion image analysis involves quantifying and extracting the amount of various aberration components of the imaging. This directly indicates how the aberrations can be mitigated by realignments or modifications of the optical elements of the imaging system.

The second alignment phase involves inserting a pick-off mirror 502 before image plane-1 to divert the collected light towards imaging lens 506, which re-images the ion onto image plane-2. This second stage imaging is used to increase the overall magnification of imaging system 400 such that the imaging resolution per pixel of camera 504 (which has a lower limit on the pixel size) is maximized.

Camera 508 is added in image plane-2 and is then used to analyze the ion image, which now has a higher sensitivity to optical aberrations. This leads to finer adjustments on the high NA objective 410 position, tip and tilt such that the optical aberrations are reduced even further. For example, the position and objective tilt of high NA objective 410 may be adjusted until the optical aberrations on the ion image are minimized. The minimization can be assessed (e.g., determining how much adjustment is needed) by active alignment. This means that the image quality is improved while adjusting the position/alignment of the high NA objective. This can be done by computer software that analyzes the image continuously while adjusting the high NA objective.

In one example, suppose that high NA objective 410 has a first objective tilt value (e.g., 10 degrees) and is located in a first position (e.g., 1 mm, 5 mm, 1 mm) on an X, Y, Z plane. A user may move high NA objective 410 to a second position (e.g., move the objective a few millimeters such that the new position is (1 mm, 10 mm, 1 mm) and may tilt high NA objective 410 to a second objective tilt value (e.g., 5 degrees). Subsequent to making these changes, the user may compare a first ion image generated when the high NA objective 410 is in the first position with the first objective tilt value, with a second ion image when the high NA objective 410 is in the second position with the second objective tilt value. If the second ion image has fewer optical aberrations than the first ion image, then the alignment has improved. The user may continuously make small alignment adjustments until the resultant ion image features greater optical aberrations. In this case, the user should proceed with the alignment parameters that yielded the least aberrations.

The introduction of pick-off mirror 502, cameras 504 and 508, as well as imaging lens 506 results in imaging system 500, which is a temporary variation of imaging system 400 during the alignment process.

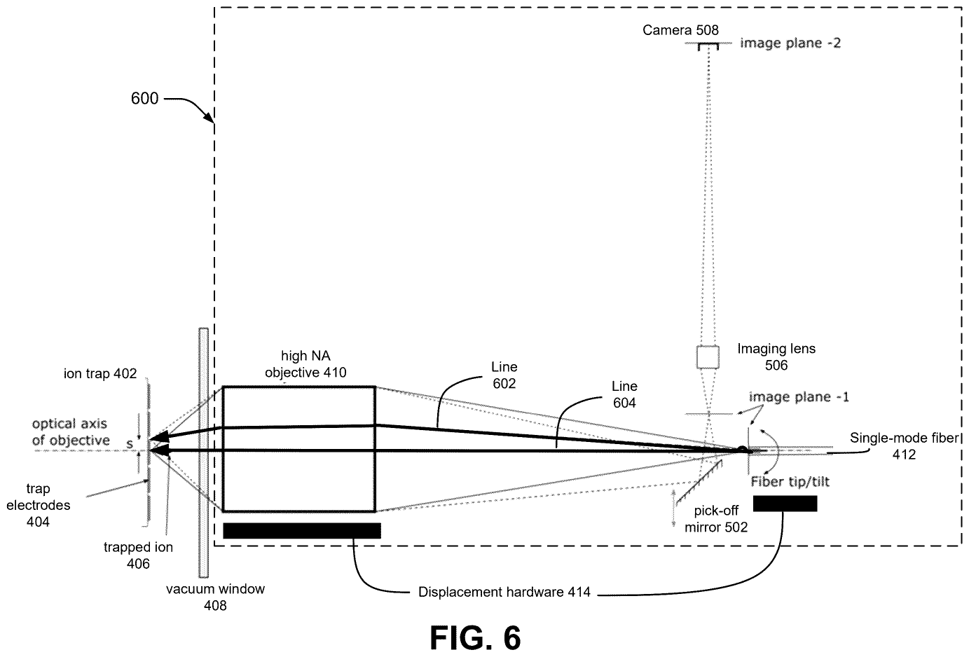

FIG. 6 illustrates an additional alignment phase for imaging system 400 that collects light emitted by trapped ion 406 into SM fiber 412. In this third alignment phase, SM fiber 412 replaces camera 504 such that SM fiber 412 is positioned at the nominal image plane-1. This results in another variation (i.e., imaging system 600) of imaging system 400 during the alignment.

Light is then injected into imaging system 600 from SM fiber 412 (this is shown by line 602) such that the light scatters off of trap electrodes 404. The scattered light is represented by the dotted lines originating from ion trap 402.

The focal position of high NA objective 410 is then adjusted to focus the fiber delivered light onto the surface of trap 402. The focal position is the distance between the objective and the trap. In other words, the position of the objective is translated along the direction of the light collection.

Pick-off mirror 502 before image plane-1 is configured to redirect the trap scattered light to the second stage imaging such that the surface of ion trap 402 may be imaged on camera 508 of image plane-2. SM fiber tip-tilt can then be adjusted such that the separation between the position of the trap scatter and the trap center (position of trapped ion 406), as shown by “s,” is minimized.

The position of the trap scatter is where the light from the fiber (line 602) hits the trap. The trap center is defined by the geometry of the trap electrodes. The trapped ion, which needs to have its florescence coupled to the SM fiber is trapped directly above the trap center. The distance between the trap scatter point and the trap center is “s.”

The trap imaging performed by camera 508 at image plane-2 is used to perform this alignment where the optimal tip-tilt on SM fiber 412 brings the trap scatter from the injected light closer to the trap center (line 604), thereby reducing the separation “s.” It should be noted that “s” cannot be minimized to zero as that would cause the trap scatter to miss the pick off mirror entirely and cannot be imaged by camera 508 at image plane-2. However, “s” may be reduced to a small value by simply bringing the pick-off mirror as close to the optical axis of objective 410 as possible without blocking any of the injected light.

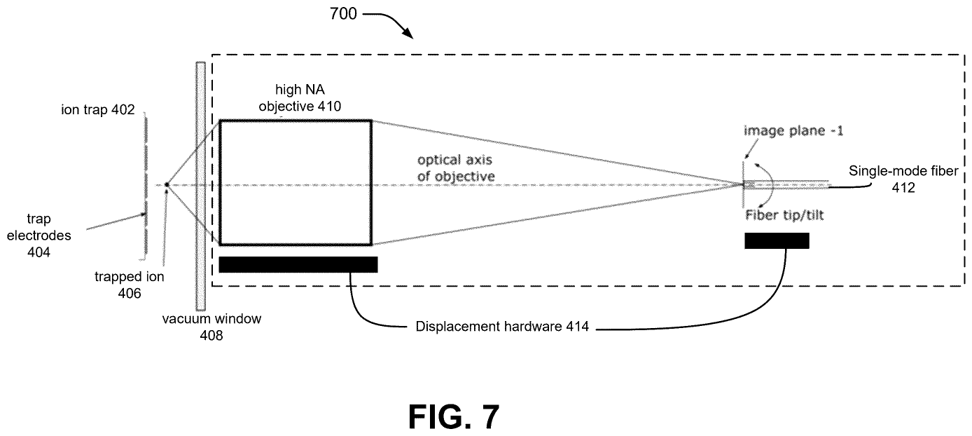

FIG. 7 illustrates two additional alignment phases for imaging system 400 that collects light emitted by trapped ion 406 into SM fiber 412. In the fourth alignment phase, high NA objective 410 is shifted in the focal direction as well as the transverse directions to image trapped ion 406 (instead of the trap surface) on SM fiber 412. The collected ion fluorescence into SM fiber 412 may be detected using a photomultiplier tube and serves as a signal that is to be maximized by translating the high NA objective 410 in X, Y, Z plane. Lastly, in the fifth alignment phase, the fiber tip/tilt of SM fiber 412 is adjusted to maximize coupled light from trapped ion 406 into SM fiber 412. After the execution of the fifth alignment phase, imaging system 400 becomes imaging system 700 in which the objective tilt angle and the fiber tilt angle are minimized to zero.

According to an exemplary aspect, alignment phases 2-5 may be repeated more than once to improve mode matching. For this iterative process, SM fiber 412 may be left in place and does not need to be interchanged with a camera 504 at image plane-1. The iterative process may be stopped at the point where there is no further improvement in the mode-matching.

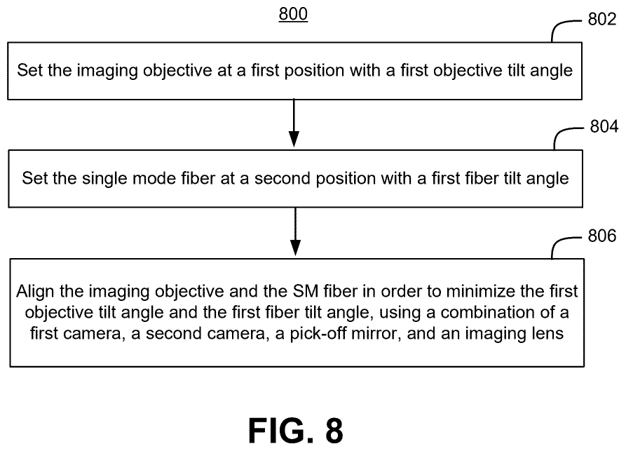

FIG. 8 illustrates method 800 for collecting light emitted by a trapped ion into the SM fiber. At 802, hardware configured to precisely displace components of an imaging system (displacement hardware 414) may set an imaging objective (e.g., high NA objective 410) at a first position. The displacement hardware may be a movable mount or a robotic arm. In some aspects, the imaging objective has a numerical aperture greater than a threshold numerical aperture. More specifically, the NA should theoretically be as large as possible in order to increase the photon collection efficiency into the SM fiber, but is practically limited by the available optical access of the ion trap hardware. It is therefore a large NA objective only limited by the optical access provided by the hardware.

Suppose that the on an X, Y, Z scale, the imaging objective is positioned at location (0, 0, 0). This may be the origin point and may represent a point on the imaging objective (e.g., the midpoint). The imaging objective may particularly be oriented at a first objective tilt angle (see objective tilt in FIG. 4) that is an angle between an optical axis of the imaging objective and a normal axis to one or more vacuum windows. Suppose that the first objective tilt angle is 25 degrees.

At 804, the displacement hardware 414 is configured to set a single mode fiber (e.g., SM fiber 412) at a second position with a first fiber tilt angle (see fiber tip/tilt in FIG. 4). Suppose that the coordinates of the second position are (0, 30, 5) and the first fiber tilt angle is 10 degrees. The second position may represent a point on the SM fiber (e.g., the center point of the tip). In this case, the first objective tilt angle is an angle between an optical axis of the imaging objective and a normal axis to the one or more vacuum windows (e.g., vacuum window 408). The second position suggests that both the imaging objective and the SM fiber share the same X plane, but the SM fiber is 30 units away in the Y-direction and 5 units away in the Z-direction. The units may be micrometers.

At 806, the displacement hardware 414 aligns the imaging objective and the SM fiber in order to minimize the first objective tilt angle and the first fiber tilt angle, using a combination of a first camera (e.g., camera 504), a second camera (e.g., camera 508), a pick-off mirror (e.g., pick-off mirror 502), and an imaging lens (e.g., imaging lens 506). Ideally, the alignment at 806 reduces both the first objective tilt angle and the first fiber tilt angle to zero degrees.

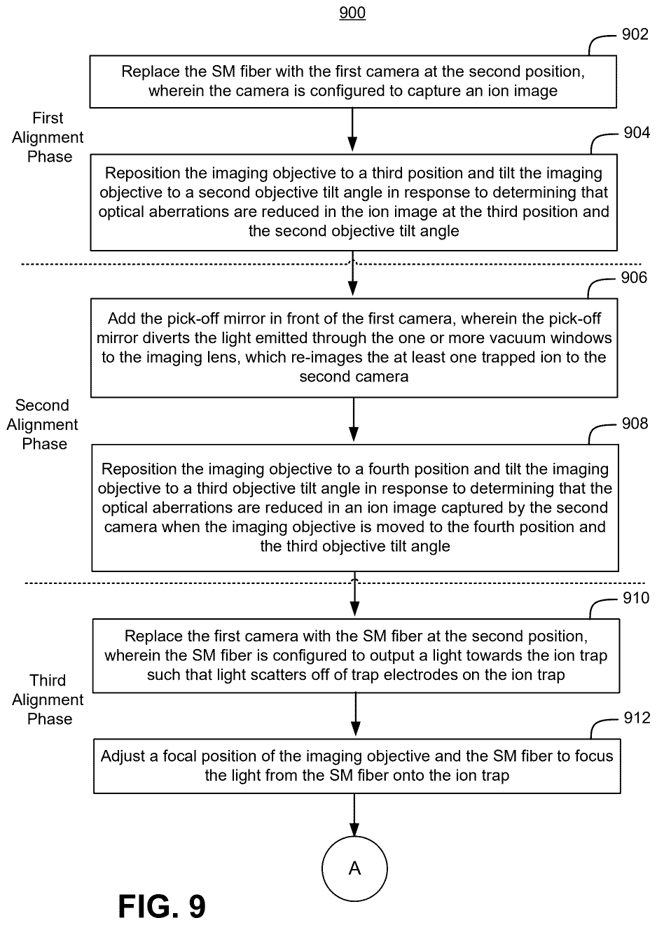

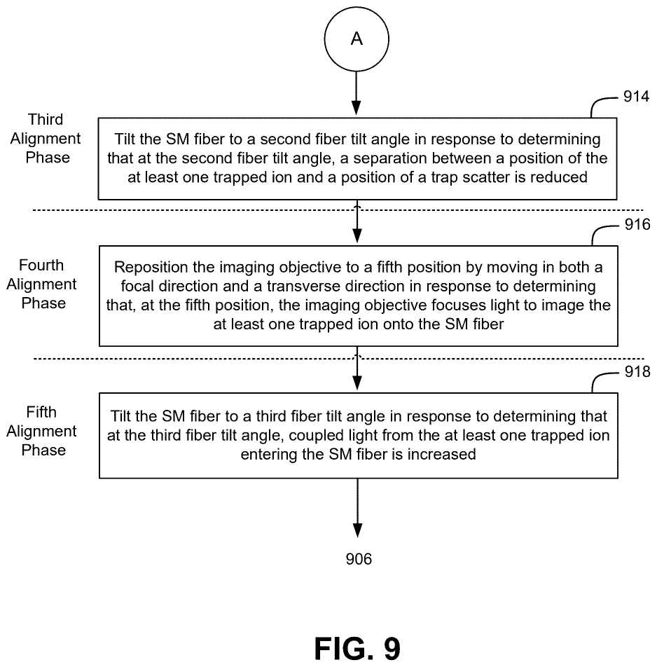

FIG. 9 illustrates detailed method 900 for collecting light emitted by a trapped ion into the SM fiber across various alignment phases. Method 900 expands on the alignment process occurring at 806 in method 800.

In some aspects, the first alignment phase includes 902 and 904. The second alignment phase includes 906 and 908. The third alignment phase includes 910, 912, and 914. The fourth alignment phase includes 916. The fifth alignment phase includes 918.

At 902, the displacement hardware 414 replaces the SM fiber with the first camera (e.g., camera 504 as shown in FIG. 5) at the second position. This camera is configured to capture an ion image from ion trap 402.

At 904, the displacement hardware 414 repositions the imaging objective to a third position (e.g., with coordinates (0, 3, 0) and tilts the imaging objective to a second objective tilt angle (e.g., 20 degrees) in response to determining that optical aberrations are reduced in the ion image at the third position and the second objective tilt angle.

At 906, the displacement hardware 414 adds the pick-off mirror (e.g., in front of the first camera, wherein the pick-off mirror diverts the light emitted through the one or more vacuum windows to the imaging lens, which re-images the at least one trapped ion to the second camera. This alignment is shown in FIG. 5.

At 908, the displacement hardware 414 repositions the imaging objective to a fourth position (e.g., 0, 4, 3) and tilting the imaging objective to a third objective tilt angle (e.g., 5 degrees) in response to determining that the optical aberrations are reduced in an ion image captured by the second camera when the imaging objective is moved to the fourth position and the third objective tilt angle.

At 910, the displacement hardware 414 replaces the first camera with the SM fiber at the second position, wherein the SM fiber is configured to output a light towards the ion trap such that light scatters off of trap electrodes on the ion trap. The pick-off mirror redirects this light scattered to the imaging lens, which re-images the ion trap on the second camera.

At 912, the displacement hardware 414 adjusts a focal position of the imaging objective to focus the light from the SM fiber onto the ion trap. For example, the imaging objective may be moved to position (0, 5, 3).

At 914, the displacement hardware 414 tilts the SM fiber to a second fiber tilt angle (e.g., 3 degrees) in response to determining that at the second fiber tilt angle, a separation between a position of the at least one trapped ion and a position of a trap scatter is reduced.

At 916, the displacement hardware 414 repositions the imaging objective to a fifth position (e.g., 0, 7, 5) by moving in both a focal direction and a transverse direction in response to determining that, at the fifth position, the imaging objective focuses light to image the at least one trapped ion onto the SM fiber.

At 918, the displacement hardware 414 tilts the SM fiber to a third fiber tilt angle (e.g., 0 degrees) in response to determining that at the third fiber tilt angle, coupled light from the at least one trapped ion entering the SM fiber is increased.

In some aspects, method 900 may loop back to 906 in order to further align the imaging objective and the SM fiber. For example, in the exemplary values given above, it appears that the tilt angles are not zero degrees. Accordingly, in another iteration of method 900 starting from 906, the alignment may be improved.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A quantum information processing (QIP) system comprising:
a vacuum enclosure with one or more vacuum windows allowing transmission of light in and out of the vacuum enclosure;
an ion trap, inside the vacuum enclosure, configured to trap at least one ion;
an imaging objective, located at a first position, configured to focus light emitted through the one or more vacuum windows from the at least one trapped ion into a single mode (SM) fiber at a second position, wherein the imaging objective has a first objective tilt angle between an optical axis of the imaging objective and a normal axis to the one or more vacuum windows, and the SM fiber has a first fiber tilt angle between an axis of the SM fiber and the optical axis of the imaging objective; and
a first camera, a second camera, a pick-off mirror, and an imaging lens, used in combination to align the imaging objective and the SM fiber in order to minimize the first objective tilt angle and the first fiber tilt angle.

2. The QIP system of claim 1, wherein in a first alignment phase:
the first camera is configured to replace the SM fiber at the second position and is configured to capture an ion image, wherein the imaging objective is repositioned to a third position and is tilted to a second objective tilt angle in response to determining that optical aberrations are reduced in the ion image at the third position and the second objective tilt angle.

3. The QIP system of claim 2, wherein the imaging objective is configured to be repositioned from the first position to the third position by moving the imaging objective in at least one of X, Y, Z directions in an X, Y, Z plane.

4. The QIP system of claim 2, wherein in a second alignment phase:
the pick-off mirror is added in front of the first camera and is configured to divert the light emitted through the one or more vacuum windows to the imaging lens, which re-images the at least one trapped ion to the second camera.

5. The QIP system of claim 4, wherein the imaging objective is configured to be repositioned to a fourth position and is tilted to a third objective tilt angle in response to determining that the optical aberrations are reduced in an ion image captured by the second camera when the imaging objective is moved to the fourth position and the third objective tilt angle.

6. The QIP system of claim 4, wherein in a third alignment phase:
the SM fiber is configured to replace the first camera at the second position, and the SM fiber is configured to output a light towards the ion trap such that light scatters off of trap electrodes on the ion trap,
wherein the pick-off mirror is configured to redirect the light scattered to the imaging lens, which re-images the ion trap on the second camera.

7. The QIP system of claim 6, wherein a focal position of the imaging objective is adjusted to focus the light from the SM fiber onto the ion trap.

8. The QIP system of claim 6, wherein the SM fiber is tilted to a second fiber tilt angle in response to determining that at the second fiber tilt angle, such that a separation between a position of the at least one trapped ion and a position of a trap scatter is reduced.

9. The QIP system of claim 6, wherein in a fourth alignment phase:
the imaging objective is configured to be repositioned to a fifth position by moving in both a focal direction and a transverse direction in response to determining that, at the fifth position, the imaging objective focuses light to image the at least one trapped ion on the SM fiber.

10. The QIP system of claim 9, wherein in a fifth alignment phase:
the SM fiber is tilted to a third fiber tilt angle in response to determining that at the third fiber tilt angle, coupled light from the at least one trapped ion entering the SM fiber is increased.

11. The QIP system of claim 1, wherein the imaging objective has a numerical aperture greater than a threshold numerical aperture.

12. A method for aligning an imaging objective and a single mode (SM) fiber in a quantum information processing (QIP) system, the method comprising:
setting the imaging objective at a first position, wherein the imaging objective focuses light emitted through one or more vacuum windows from at least one trapped ion into the SM fiber located at a second position, wherein the imaging objective has a first objective tilt angle between an optical axis of the imaging objective and a normal axis to the one or more vacuum windows, and the SM fiber has a first fiber tilt angle between an axis of the SM fiber and the optical axis of the imaging objective; and
aligning the imaging objective and the SM fiber in order to minimize the first objective tilt angle and the first fiber tilt angle, using a combination of a first camera, a second camera, a pick-off mirror, and an imaging lens.

13. The method of claim 12, wherein aligning the imaging objective and the SM fiber comprises, in a first alignment phase:
replacing the SM fiber with the first camera at the second position, wherein the camera is configured to capture an ion image;
repositioning the imaging objective to a third position and tilting the imaging objective to a second objective tilt angle in response to determining that optical aberrations are reduced in the ion image at the third position and the second objective tilt angle.

14. The method of claim 13, wherein repositioning the imaging objective from the first position to the third position comprises moving the imaging objective in at least one of X, Y, Z directions in an X, Y, Z plane.

15. The method of claim 13, further comprising in a second alignment phase:
adding the pick-off mirror in front of the first camera, wherein the pick-off mirror diverts the light emitted through the one or more vacuum windows to the imaging lens, which re-images the at least one trapped ion to the second camera.

16. The method of claim 15, further comprising:
repositioning the imaging objective to a fourth position and tilting the imaging objective to a third objective tilt angle in response to determining that the optical aberrations are reduced in an ion image captured by the second camera when the imaging objective is moved to the fourth position and the third objective tilt angle.

17. The method of claim 15, further comprising in a third alignment phase:
replacing the first camera with the SM fiber at the second position, wherein the SM fiber is configured to output a light towards the ion trap such that light scatters off of trap electrodes on the ion trap,
wherein the pick-off mirror redirects the light scattered to the imaging lens, which re-images the ion trap on the second camera.

18. The method of claim 17, further comprising:
adjusting a focal position of the imaging objective to focus the light from the SM fiber onto the ion trap.

19. The method of claim 17, further comprising:
tilting the SM fiber to a second fiber tilt angle in response to determining that at the second fiber tilt angle, a separation between a position of the at least one trapped ion and a position of a trap scatter is reduced.

20. The method of claim 17, further comprising in a fourth alignment phase:
repositioning the imaging objective to a fifth position by moving in both a focal direction and a transverse direction in response to determining that, at the fifth position, the imaging objective focuses light to image the at least one trapped ion onto the SM fiber.

21. The method of claim 20, further comprising in a fifth alignment phase:
tilting the SM fiber to a third fiber tilt angle in response to determining that at the third fiber tilt angle, coupled light from the at least one trapped ion entering the SM fiber is increased.
